(19) United States
(12) Patent Application Publication
(10) Pub. No.: US 2012/0137982 A1
(43) Pub. Date: Jun. 7, 2012

(54) ANIMAL LITTER COMPRISING AN ORGANIC SUBSTRATE AND A WICKING AGENT FOR IMPROVED ABSORBANCY

(76) Inventor: Andrew J. Skulan, Pleasanton, CA (US)

(21) Appl. No.: 12/960,778

(22) Filed: Dec. 6, 2010

(51) Int. Cl. A01K 29/00; A01K 1/01

(52) U.S. Cl. 119/172; 119/171; 119/173

(57) ABSTRACT

Granulized litter compositions comprising a natural organic litter substrate for absorbing urine or other liquid. In order to improve the wicking ability of such “green” litter granules, which are initially slow to absorb liquid, the litter composition further includes a wicking agent to more quickly wick urine or other liquid into the natural organic litter substrate, where it is absorbed. In one embodiment, the wicking agent is provided as granules separate from the natural organic litter granules. In another embodiment, the wicking agent comprises a coating applied over at least some of the natural organic litter granules. The presence of the wicking agent advantageously improves the ability of urine or other liquid to be quickly absorbed so as to minimize and/or prevent any pooling that would otherwise occur.

### BACKGROUND OF THE INVENTION

1. The Field of the Invention

The present invention relates to litter for use by domestic animals. For example, such litter is typically employed by pet owners to absorb urine and collect feces.

2. Background and Relevant Art

Many people enjoy the company of one or more domestic pets. Litter boxes are typically provided for the use of such animals in the collection of urine and feces. Such a litter box is typically filled with an absorbent granular material (e.g., sand and/or clay), which aids in collecting the bodily wastes produced by pets. More recently, it has become particularly desirable to employ a “green” granular litter material derived from natural organic materials, such as those resulting as byproducts of agricultural operations.

One continuing difficulty with such materials is the tendency for urine to remain on the surface of the litter granules, rather than being rapidly absorbed. Because the urine is not rapidly absorbed, it tends to run off to the lowest locations within the litter box (e.g., the edges and corners), pooling in these locations under force of gravity. Urine run-off may increase the surface area of the urine, further promoting release of malodorous components into the air. Furthermore, there are often insufficient litter granules adjacent these “low” pooling locations to result in full absorption of the urine. This often results in foul odor near the litter box and difficulty in removing pooled urine when cleaning the litter box. Finally, for clumping litters, run-off often results in irregularly shaped, relatively weak clumps that can be difficult to remove from the litter box

### BRIEF SUMMARY OF THE INVENTION

The present invention is directed to litter compositions for use with domestic animals that include a natural organic litter substrate for absorbing, for example, urine and or liquid associated with feces. The litter compositions further include a wicking agent to more quickly wick liquid (e.g., urine) into the natural organic litter substrate. The presence of the wicking agent advantageously improves the ability of urine or other liquid to be quickly absorbed so as to minimize and/or prevent any pooling that would otherwise occur.

In one embodiment, both the natural organic substrate and the wicking agent are in the form of granules, each separate from one another, but in which the natural organic granules and the wicking agent granules are mixed together. In such an embodiment, some of the granules are natural organic substrate granules, while others are comprised of a different material that is particularly configured to quickly wick liquid into the granule, after which it is absorbed from the wicking material granule into adjacent natural organic granules.

In another embodiment, the wicking agent comprises a coating that is applied over at least some of the natural organic litter substrate granules. In such an embodiment, at least some, and preferably each natural organic substrate granule may include the wicking agent coating. Upon contact with urine or other liquid, the liquid is quickly absorbed into the wicking agent coating, and thereafter into the natural organic core of the litter granules.

Additional features and advantages of exemplary implementations of the present invention will be set forth in the description which follows, and in part will be evident from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### DETAILED DESCRIPTION OF THE PREFERRED EMBODIMENTS

### I. Introduction

The present invention is directed to granulized litter compositions comprising a natural organic litter substrate for absorbing urine or other liquid. Such natural organic litter substrates (e.g., derived from cellulosic materials such as wood, corn, wheat, tea leaves, walnut shells, grasses, or other agricultural byproducts) are typically significantly slower in absorbing liquids than traditionally used clay based absorbent litters. In order to improve the wicking ability of such “green” litter granules, the litter composition further includes a wicking agent to more quickly wick liquid (e.g., urine) into the natural organic litter substrate, where it is absorbed. The presence of the wicking agent advantageously improves the ability of urine or other liquid to be quickly absorbed so as to minimize and/or prevent any pooling that would otherwise occur.

### II. Exemplary Litter Compositions

In one embodiment, the litter composition comprises a mixture of at least two different types of granules. Such a composition includes natural organic litter substrate granules, as well as wicking agent granules. By way of example, the natural organic litter substrate granules may comprise one or more byproducts of agricultural activities. Such agricultural byproducts are typically cellulosic materials, examples of which include, but are not limited to, wood, corn, wheat, tea leaves, walnut shells, or grasses. Other absorbent cellulosic materials that may be suitable will be apparent to one of skill in the art. The inclusion of such natural organic litter granules within the composition is advantageous, as such materials are “green”, which many consumers desire. In particular, the use of such agricultural byproducts within the product reduces waste streams resulting from such agricultural activities, finding advantageous and desirable uses for otherwise waste materials. The use and integration of such waste byproducts within a product desired by consumers provides for more responsible management of environmental impacts of the various manufacturing processes. In addition, it can increase profitability by using what was otherwise a waste material in the production of a consumer product.

Although natural organic granules are capable of absorbing liquids so as to function as an absorbent litter composition, such natural organic granules exhibit relatively slow absorption as compared to more traditionally employed substrate materials, (e.g., bentonite clay). As a result, the inventor has observed that urine or other liquid tends to pool on the surface of the granules, and after a period of initial wetting (e.g., about 3-5 seconds) of granules immediately adjacent the liquid pool, the liquid is rapidly absorbed (e.g., within about 1 second) into adjacent granules. In other words, the relatively lengthy period of initial wetting of surface granules in contact with the liquid is followed by rapid absorption of the liquid into adjacent, deeper granules once initial wetting of the surface granules has occurred. Because of the relatively slow period over which initial wetting of the surface granules occurs, liquid continues to pool, and then runoff to the lowest locations within the litter box (i.e., often the corners and edges of the box) results. Pooling and runoff often occurs before the surface granules have sufficient time to pass through the initial wetting period.

Inclusion of wicking agent granules within the composition significantly speeds the initial wetting stage, resulting in rapid initial wetting of the specially configured wicking agent granules. The inventor has observed that providing a small fraction of wicking agent granules allows these specially configured granules to quickly absorb liquid, while transfer of the liquid from the wetted wicking agent granules to adjacent natural organic granules is rapidly accomplished. Thus, the inclusion of a small fraction of wicking agent granules minimizes and/or prevents runoff associated with liquid pooling that has been observed when employing natural organic litter granules.

In one embodiment, the wicking agent granules comprise one or more of calcium bentonite, sodium bentonite, diatomaceous earth, shale, gypsum, paper, or combinations thereof. Other examples of wicking agent granules may comprise absorbent polymers (e.g., crosslinked polyacrylic acid, polyvinyl pyrrolidone, polyethylene, and combinations thereof), water soluble inorganic salts or oxides (e.g. sodium borate, magnesium aluminum silicate, alumina, titanium dioxide, silicon dioxide), non-woven polymer agglomerates (e.g., fibrous viscose, rayon, polyester, or and combinations thereof), crystalline short chain carbohydrates (e.g., mono-saccharides, di-saccharides, or combinations thereof), and combinations thereof. Specific examples of crystalline short chain carbohydrates include, but are not limited to sucrose, dextrin, and combinations thereof.

The inventors have found that only a relatively small fraction of wicking agent granules need to be included within the composition mixture in order to minimize and/or prevent runoff and liquid pooling. For example, the wicking agent granules may comprise between about 0.5 percent and about 20 percent of the litter composition by volume, more preferably between about 1 percent and about 10 percent by volume, and most preferably between about 3 percent and about 7 percent of the litter composition by volume.

Similarly, the natural organic granules may comprise between about 99.5 percent and about 80 percent of the litter composition by volume, more preferably between about 99 percent and about 90 percent by volume, and most preferably between about 93 percent and about 97 percent of the litter composition by volume. A small fraction of wicking agent granules is advantageously sufficient to quickly absorb liquid into the wicking agent granules, after which the liquid is quickly transferred into adjacent granules of the mixture, preventing and/or minimizing runoff of the liquid.

The inventor has further found that providing the different granule types in approximately equal granule size is preferred, as it further improves absorption of liquid through the initial wetting phase, as well as transfer of liquid from one wetted granule to adjacent dry granules. More specifically, the average particle size of wicking agent granules and natural organic granules are preferably within about ±50 percent of one another, more preferably within about ±25 percent of one another, and most preferably within about ±10 percent of one another. Particle size for both wicking agent granules and natural organic granules is preferably between about 0.2 mm and about 10 mm, more preferably between about 0.3 mm and about 8 mm, and most preferably between about 0.5 mm and about 4 mm.

In one embodiment, the wicking agent granules may be larger and/or have a lower density than the natural organic granules. For example, larger and/or lower density wicking particles may exhibit greater buoyancy in the litter matrix, resulting in a greater population of wicking particles on the upper surface of the litter.

In an alternative embodiment, the composition comprises natural organic litter granules that include a wicking agent coating applied so as to coat at least some of the natural organic granules. Such a coating may be applied by any suitable method, although spraying is particularly preferred. Alternative application methods (e.g., dipping, etc.) will be apparent to one skilled in the art. In such an embodiment, the natural organic granules comprise a natural material as described above (e.g., a cellulosic material that is a byproduct of an agricultural operation). The wicking agent coating may comprise a fatty acid, a surfactant (e.g., a nonionic surfactant such as a polysorbate surfactant), a hydrophilic siloxane-based polymer, a polyanaline, a polymethyl methacrylate (PMMA), a polyvinyl sulfate, or combinations thereof.

In another embodiment, the wicking agent coating may comprise a nanoparticle and/or nanofilm coating applied over the natural organic litter granules. Exemplary nanoparticles and/or nanofilms include, but are not limited to, silica, iron, titania, alumina, silica doped titania, and combinations thereof. In one embodiment, the coating may be sprayed or otherwise coated onto the natural organic granules as a liquid (e.g., a liquid mixture or emulsion including the wicking agent and a solvent or carrier).

In such embodiments in which the wicking agent is coated onto the litter granule substrate, a wide variety of substrate materials may be employed, such as those described above, or other materials such as fibrous polymer granules (e.g., cotton, polyester, or other natural or synthetic polymers), polymeric open-cell foams, slow absorbing clays, or other slow absorbing mineral materials which do not readily wet when exposed to aqueous solutions.

In embodiments including a wicking agent coating applied over the natural organic granule substrate, significantly less wicking agent is required. For example, the wicking agent coating may comprise between about 0.1 percent and about 1 percent of the litter composition by volume, more preferably between about 0.15 percent and about 0.5 percent by volume, and most preferably between about 0.2 percent and about 0.3 percent of the litter composition by volume. The fraction by weight may be similar where the densities of the materials are similar.

Without limitation, the following hypothetical examples illustrate some exemplary implementations of the present invention:

| Example | Natural/Organic | Vol. | Wicking Agent | Vol. | Granule | |
|---|---|---|---|---|---|---|
| No. | Granules | % | Granules | % | Size | |
| 1 | Pine wood litter | 95 | Ca bentonite | 5 | 2 | mm |
| | granules | | granules | | | |
| 2 | Pine wood litter | 90 | Ca bentonite | 10 | 2 | mm |
| | granules | | granules | | | |
| 3 | Pine wood litter | 97 | Ca bentonite | 3 | 2 | mm |
| | granules | | granules | | | |
| 4 | Pine wood litter | 95 | Ca bentonite | 5 | 0.5 | mm |
| | granules | | granules | | | |
| 5 | Pine wood litter | 90 | Ca bentonite | 10 | 0.5 | mm |
| | granules | | granules | | | |
| 6 | Pine wood litter | 97 | Ca bentonite | 3 | 0.5 | mm |
| | granules | | granules | | | |
| 7 | Pine wood litter | 95 | Ca bentonite | 5 | 4 | mm |
| | granules | | granules | | | |
| 8 | Pine wood litter | 90 | Ca bentonite | 10 | 4 | mm |
| | granules | | granules | | | |
| 9 | Pine wood litter | 97 | Ca bentonite | 3 | 4 | mm |
| | granules | | granules | | | |

The pine wood natural organic litter granules of Examples 1-9 are mixed together with the calcium bentonite wicking agent granules so as to result in a substantially homogenous mixture of the two granule types. Both the pine wood granules and the calcium bentonite granules are provided with granule or particle sizes that are approximately equal to one another. Average particle or granule sizes are as indicated in the table above. Each of Examples 1-9 provides a litter composition that exhibits improved absorbency as compared to pine wood granules alone. In use, it is observed that liquid is absorbed into the calcium bentonite wicking agent granules almost immediately on contact with the liquid. The absorbed liquid is then transferred to adjacent granules, preventing runoff and pooling of urine or other liquid over the litter composition.

In Examples 10-21, the pine wood natural organic litter granules are coated with a liquid mixture or emulsion including a fatty acid and/or nonionic surfactant wicking agent coating such as Tween-20 (polysorbate 20). The result is a litter composition where the coated granules include a core of pine wood that is coated with the wicking agent. The coated granules have an average granule size as indicated in the below table.

| Example | Natural/Organic | Wt. | Wicking Agent | Wt. | Granule | |
|---|---|---|---|---|---|---|
| No. | Substrate | % | Coating | % | Size | |
| 10 | Pine wood | 99.75 | Nonionic | 0.25 | 2 | mm |
| | substrate | | surfactant | | | |
| 11 | Pine wood | 99.5 | Nonionic | 0.5 | 2 | mm |
| | substrate | | surfactant | | | |
| 12 | Pine wood | 99.9 | Nonionic | 0.1 | 2 | mm |
| | substrate | | surfactant | | | |
| 13 | Pine wood | 99 | Nonionic | 1 | 2 | mm |
| | substrate | | surfactant | | | |
| 14 | Pine wood | 99.75 | Nonionic | 0.25 | 4 | mm |
| | substrate | | surfactant | | | |
| 15 | Pine wood | 99.5 | Nonionic | 0.5 | 4 | mm |
| | substrate | | surfactant | | | |
| 16 | Pine wood | 99.9 | Nonionic | 0.1 | 4 | mm |
| | substrate | | surfactant | | | |
| 17 | Pine wood | 99 | Nonionic | 1 | 4 | mm |
| | substrate | | surfactant | | | |
| 18 | Pine wood | 99.75 | Nonionic | 0.25 | 0.5 | mm |
| | substrate | | surfactant | | | |
| 19 | Pine wood | 99.5 | Nonionic | 0.5 | 0.5 | mm |
| | substrate | | surfactant | | | |
| 20 | Pine wood | 99.9 | Nonionic | 0.1 | 0.5 | mm |
| | substrate | | surfactant | | | |
| 21 | Pine wood | 99 | Nonionic | 1 | 0.5 | mm |
| | substrate | | surfactant | | | |

Each of Examples 10-21 provides a litter composition that exhibits improved absorbency as compared to pine wood granules alone. In use, it is observed that liquid is absorbed into the coated granules almost immediately on contact with the liquid. The absorbed liquid is then transferred to deeper adjacent granules, preventing runoff and pooling of urine or other liquid over the litter composition.

One will appreciate in light of the disclosure herein that the present invention may be embodied in other specific forms without departing from its spirit or essential characteristics. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. An absorbent litter composition, comprising:
a natural organic litter substrate; and
a wicking agent configured to wick liquid away from a surface of the litter composition so as to speed wetting of the natural organic litter substrate such that any tendency of a liquid to pool on and/or runoff the litter composition surface rather than be quickly absorbed into the natural organic litter substrate is minimized or prevented.

2. The composition of claim 1, wherein the organic litter substrate comprises cellulosic granules selected from the group consisting of wood, corn, wheat, tea leaves, walnut shells, grasses, and combinations thereof.

3. The composition of claim 1, wherein the wicking agent comprises granules selected from the group consisting of calcium bentonite, sodium bentonite, diatomaceous earth, shale, gypsum, paper, and combinations thereof.

4. The composition of claim 1, wherein the wicking agent comprises granules selected from the group consisting of absorbent polymers, water soluble salts, crystalline mono-saccharides, crystalline di-saccharides, non-woven polymer agglomerates, and combinations thereof.

5. An absorbent litter composition comprising a mixture of granules, the composition comprising:
a natural organic litter substrate, the natural organic substrate comprising granules; and
a wicking agent, the wicking agent comprising granules, the wicking agent granules being configured to wick liquid away from a surface of the litter composition so as to speed wetting of the natural organic litter substrate granules such that any tendency of a liquid to pool on and/or runoff the litter composition surface rather than be quickly absorbed into the natural organic litter substrate is minimized or prevented;
wherein the natural organic granules and the wicking agent granules are mixed together.

6. The composition of claim 5, wherein the natural organic substrate comprises cellulosic granules selected from the group consisting of wood, corn, wheat, tea leaves, walnut shells, grasses, and combinations thereof.

7. The composition of claim 5, wherein the wicking agent comprises granules selected from the group consisting of calcium bentonite, sodium bentonite, diatomaceous earth, shale, gypsum, paper, and combinations thereof.

8. The composition of claim 5, wherein the wicking agent comprises granules selected from the group consisting of absorbent polymers, water soluble inorganic salts or oxides, crystalline mono-saccharides, crystalline di-saccharides, non-woven polymer agglomerates, and combinations thereof.

9. The composition of claim 5, wherein the wicking agent granules comprise between about 0.5 percent and about 20 percent of the litter composition by volume.

10. The composition of claim 5, wherein the wicking agent granules comprise between about 1 percent and about 10 percent of the litter composition by volume.

11. The composition of claim 5, wherein the wicking agent granules comprise between about 3 percent and about 7 percent of the litter composition by volume.

12. The composition of claim 5, wherein the wicking agent granules have a particle size that is approximately equal to the natural organic substrate granules.

13. The composition of claim 5, wherein the wicking agent granules and the natural organic substrate granules are substantially homogenously mixed throughout the litter composition.

14. An absorbent litter composition, comprising:
a natural organic litter substrate, the natural organic substrate comprising granules; and
a wicking agent, the wicking agent coating at least some of the natural organic litter substrate granules, the wicking agent coating being configured to wick liquid away from a surface of the litter composition so as to speed wetting of the natural organic litter substrate such that any tendency of a liquid to pool and/or runoff the litter composition surface rather than be quickly absorbed into the natural organic litter substrate is minimized or prevented.

15. The composition of claim 14, wherein the natural organic substrate comprises cellulosic granules selected from the group consisting of wood, corn, wheat, tea leaves, walnut shells, grasses, and combinations thereof.

16. The composition of claim 14, wherein the wicking agent coating comprises a coating selected from the group consisting of fatty acids, nonionic surfactants, hydrophilic siloxane-based polymers, polyanilines, polymethylmethacrylates, polyvinyl sulfonates, and combinations thereof.

17. The composition of claim 14, wherein the wicking agent coating comprises a nanoparticle and/or nanofilm coating selected from the group consisting of silica, iron, titania, alumina, silica doped titania, and combinations thereof.

18. The composition of claim 14, wherein the wicking agent coating comprises between about 0.1 percent and about 1 percent of the litter composition by volume.

19. The composition of claim 14, wherein the wicking agent coating comprises between about 0.15 percent and about 0.5 percent of the litter composition by volume.

20. The composition of claim 14, wherein the wicking agent coating comprises between about 0.2 percent and about 0.3 percent of the litter composition by volume.
